(19) United States
(12) Patent Application Publication
(10) Pub. No.: US 2009/0055131 A1
(43) Pub. Date: Feb. 26, 2009

(54) AUTOMATIC RECORDING VOLUME MEASUREMENT APPARATUS

(76) Inventors: Shmuel Bukshpan, Ramat Hasharon (IL); Gleb Zilberstein, Rehovot (IL)

Correspondence Address: WINSTON & STRAWN LLP;PATENT DEPARTMENT, 1700 K STREET, N.W., WASHINGTON, DC, 20006, US

(21) Appl. No.: 11/912,022

(22) PCT Filed: Apr. 20, 2006
(86) PCT No.: PCT/IL06/00493

§ 371 Date: Apr. 30, 2008

Related U.S. Application Data
(60) Provisional application No. 60/672,988, filed on Apr. 20, 2005.

(51) Int. Cl. G06F 17/40

(52) U.S. Cl. 702/187

(57) ABSTRACT

Data acquisition apparatus for use with a fluid dispensing device and providing an electronic record of the precise volumes of fluid dispensed from the fluid dispensing device. The fluid dispensing device may be laboratory or clinical apparatus such as an automatic or manual pipette. The apparatus generally includes a fluid volume sensor for detecting the volume of fluid released from the fluid dispensing device and producing electrical signals determined by the volume of fluid released from the device, a data transmission device configured to receive the electrical signals, and a data storage device for storing them.

### FIELD OF THE INVENTION

The present invention relates generally to the tracking and recording of the volumes of fluid dispensed from laboratory or clinical apparatus and the provision of an electronic record of the data, especially including manual and automated pipettes.

### BACKGROUND OF THE INVENTION

Accurate recording of data in a manner that permits retrieval of these data as required is an essential feature of good laboratory and clinical practice. It is generally acknowledged that manual recording of data is both error prone and time consuming, and therefore it would be beneficial to devise methods of data acquisition and storage that do not rely solely on the discretion of the technician or practitioner. In both laboratory and clinical settings many different devices or apparatus are utilized routinely that would benefit from the generation of an independent record of their operations. The data that may be recorded from such devices typically include time of operation and one or more specific physical parameter as exemplified by volume, temperature, speed and duration of rotation, and the like. Prevalent examples of operations that require an accurate record include but are not limited to volumes dispensed by fluid dispensing devices such as pipettes, intravenous or other infusion lines, feeding tubes, column fractionation equipment and the like.

Pipettes are one of the most widely used devices, indispensable in chemical and biochemical laboratories. Precision pipettes have made chemical assays accurate and reproducible. In addition to constantly improving the quality and design of the simple mechanical pipettes, the market sees expansion of electronic pipettes and multi-pipettes. Pipettes have evolved from relatively simple straw-type structures to sophisticated electronic hand-held devices that exhibit a great degree of precision.

Typically, for a technician in a laboratory environment, pipetting may occupy a considerable percentage of his/her time. Pipette users perform extremely large numbers of operations to dispense measured volumes of reagents and solutions. This work requires great accuracy.

Among the pipette users' critical needs are the precise measurement of dispensed volume, and the accurate recording of the dispensed volume data into a laboratory notebook as required by standard scientific documentation procedures. The requirement to record dispensed volume data is cumbersome and time consuming and often interrupts the flow of work where a large number of consecutive dispensing operations with pipettes is required. In addition, the manually recording of this data is an error prone activity.

U.S. Pat. Nos. 4,567,780; 5,892,161 and 6,428,750 describe mechanical and electronic apparatus for displaying the volume setting of the pipette on a device attached to or placed within the housing of the pipette. Nevertheless, these devices merely display the volume setting or dispensed volume, and have no mechanism for recording volume data. Thus, these devices do not permit automatic recordal of pipette dispensing data, thereby relieving the pipette user from this burden.

At the other end of the spectrum are the robotic pipette workstations, as described for example in U.S. Pat. No. 4,896,270. These expensive and sophisticated devices allow for the dispensing of predetermined volumes of liquid using a motor driven pump which is controlled by and receives instructions from a computing device. These instructions are stored in persistent memory and are transmitted through a cable connecting the computing device to the motor driven pump. Driver software allows the pipette workstations to execute a series of dispensing operations according to a predetermined protocol.

A battery powered, microprocessor controlled portable electronic pipette is disclosed in U.S. Pat. No. 6,254,832. This pipette comprises a hand holdable housing supporting a battery, a linear actuator for driving a plunger lengthwise in a cylinder to aspirate and dispense fluid into and from a pipette tip extending from the housing and a control circuit for the linear actuator. The handheld electronic pipette disclosed does not provide any means of storing the data to persistent memory.

U.S. Pat. No. 5,892,161 discloses the use of one or more Hall effect transducers to sense the volume setting of a mechanical pipette and display this value electronically, but does not suggest exporting any data to persistent storage.

U.S. Pat. No. 4,567,780 provides for the use of a potentiometer to sense the volume setting of the pipette and to output this value to an electronic display, but does not suggest exporting any data to persistent storage.

U.S. Pat. No. 5,582,798 discloses a volume sensing device for approximately determining the volume of liquid present in a standard plastic disposable pipette. In one embodiment disclosed in U.S. Pat. No. 5,582,798, the volume sensor outputs data to a computer data storage device. The disclosure in U.S. Pat. No. 5,582,798 is directed to sensing the amount volume of liquid present in a standard plastic disposable pipette at a given moment, and there is no suggestion of sensing or recording the volume of fluid actually dispensed from the pipette tip or probe. The volume sensing device is not mounted on the pipette, and it is a requirement that the pipette be physically lowered into the volume sensing device. Furthermore, the invention requires the user to specifically and manually insert the pipette tip or probe into the volume sensing device at a predetermined velocity. In addition, the physical geometry of the disclosed system requires that if the user wants to subsequently dispense fluid from the pipette after using the disclosed apparatus to sense the volume of fluid in the pipette tip, the user must first remove the inserted pipette tip from the disclosed apparatus and then subsequently the user may dispense fluid. There is no suggestion of wireless technology to transmit the electronic output of the volume sensing device to a data storage device. There is no suggestion of mounting the volume sensing device onto the actual pipette tip or pipetting device, and the apparatus geometry disclosed in U.S. Pat. No. 5,582,798 teaches away from mounting the disclosed volume sensing device onto the pipetting device.

U.S. Pat. No. 6,650,249 discloses a wireless communications module for the remote reading of a utilities meter via a wireless modem that communicates using data packet networks. There is no disclosure of pipettes, pipettors or non-electronic devices, nor is there any mention of clinical or laboratory devices.

U.S. Patent Application Publication No. US2003/0114771 discloses a body temperature monitoring device that includes a processor unit connected electrically to a temperature detecting unit, a data storage unit, a display unit, and a control key unit. The control key unit is operable so as to control the processor unit to store periodically both temperature information corresponding to a digital temperature signal from the temperature detecting unit, and storage time information associated with the temperature information in the data storage unit. There is no disclosure of pipettes, pipettors or non-electronic devices, nor is there any suggestion of using a wireless connection to transmit temperature data to the data storage device.

U.S. Patent Application Publication No. US2003/0204371 discloses a temporary wireless network system for controlling, collecting, processing, and responding to data generated by a plurality of sensors configured for measuring data associated with operation of, and the environment related to, commercial, industrial and manufacturing operations, processes and equipment located within a fixed geographic area. In addition, this application suggests communicating collected operational or environmental data associated with an industrial process to a general-purpose computer for storing, querying, reporting, visualizing and analyzing the data for relationships or anomalies among the data. There is no disclosure of pipettors or non-electronic devices, nor is there any mention of clinical or laboratory devices.

U.S. Patent Application Publication No. US2004/0042471 discloses a system and methods for integrating laboratory instrumentation and applications to provide a unified control and coordination architecture under a common interface. The system may be adapted to a variety of different hardware and software components wherein the individual functionalities and input/output data types for each component are recognized and incorporated into a centralized control and monitoring system. One preferred mode of that disclosure employs a computer running a laboratory instrument management system, or “LIMS”, and may include a data storage device in the system for remote storage of results after data collection. Specific laboratory instruments mentioned include robot apparatus, thermal cooler systems, mass spectroscopy systems, and electrophoresis systems. Their application makes no mention of non-electronic devices, mechanical pipettes or electronic pipettes, and the patent application does not suggest the use of wireless communication devices.

It is well known in the art that the robotic pipette devices fulfill an entirely different need than the need served by the hand held pipetting devices. Robotic pipette workstations are significantly more costly than either mechanical or electronic handheld pipettes. In addition, they are mounted on a fixed platform, more bulky and do not offer the same mechanical flexibility or spontaneity of use as the ubiquitous handheld pipette.

There is thus an unmet need for a device that automatically and electronically records volume-dispensing operations as required by standard scientific documentation procedures. There is also a need for this device to be constructed such that it does not hinder the normal operation of a handheld pipetting device, allowing the user to enjoy the benefits without requiring the user to adopt other disparate and expensive technologies such as those found in robotic pipette workstations.

### SUMMARY OF THE INVENTION

The present invention relates to the automatic generation of a record of operations of common laboratory and clinical devices and apparatus in a manner that permits subsequent retrieval of the stored data from the data storage medium. Thus, according to a first aspect, the present invention provides a system for electronically recording the operations of laboratory or clinical devices.

According to another aspect, the present invention provides for transmitting data wirelessly from the laboratory or clinical device to the storage medium. Laboratory apparatus with which the invention may be used include fluid dispensing devices such as pipetting devices, intravenous or other fluid infusion lines, and column fractionation equipment; temperature sensing instruments such as thermostatic devices or thermometers; pH meters; centrifuges; and the like.

In one embodiment, the invention allows for the electronic recording and storing of pipette dispensing operations. One advantage of the invention in this embodiment is that it can be constructed from small, lightweight components and that necessary parts can be mated to a pipette without hindering the ease of normal operation of the pipette. This aspect makes it easy to adapt the technology without changing pipette usage patterns that have been prevalent in the art.

The present invention for the first time provides means for automating the process of recording pipette dispensed volume data, applicable to hand-held pipettors. According to one embodiment, the present invention further provides for the first time mobile means for automating the process of recording pipette dispensed volume data. According to another embodiment the present invention further provides for the first time wireless means for automating the process of recording pipette volume data. The user of the invention is freed from the error prone task of recording the volume dispensed from the pipette every time liquid is dispensed from the pipette. This streamlines workflow and limits the possibilities for undetected mistakes in a process where accuracy is of paramount importance.

The present invention provides means for detecting and recording the volume of liquid dispensed from a hand held or mounted pipette instrument. In one embodiment, the present invention relates to detecting and recording in real time the volume of liquid dispensed from a hand held or mounted pipette instrument.

In one embodiment, the fluid volume sensor comprises a volume setting sensor for sensing the volume setting of the pipette, a fluid dispensing sensor for detecting when the fluid is dispensed from the pipette and one or more electronic assemblies for converting both the sensed volume and the information about when fluid is released from the pipette into one or more electronic signals.

According to another embodiment, the present invention includes a fluid volume sensor which produces one or more electronic signals determined by the volume of fluid dispensed from the pipette, and a data transmission device for transmitting said electronic signals from the fluid volume sensor to a data storage device.

According to another embodiment, the data storage device receives one or more electronic signals from the transmission device and records these signals to persistent memory.

In one embodiment, the volume setting sensor monitors the pipette volume setting by tracking the rotational motion of the volume adjustment mechanism. In one embodiment, an assembly comprising an LED, an optical sensor, and a digital signal processor (DSP) tracks the rotational motion of a solid element that rotates in tandem with the volume adjustment mechanism. According to yet another preferred embodiment, the optical sensor may be a CCD device, which detects the linear motion of the plunger directly. In yet another embodiment, a Hall effect transducer assembly tracks the rotational motion of a solid element that rotates in tandem with the volume adjustment mechanism.

In yet another embodiment, the fluid volume sensor is an electronic flow meter for directly measuring the outflow of fluid dispensed from the pipette.

In yet another embodiment, the invention is designed to work with a pipette that dispenses fluid by forcing the fluid out of a capillary tube located at the distal end of the pipette, where the fluid is forced out by the stroking motion of a push rod tip or another solid element not permeable to fluid. The fluid volume sensor monitors the volumes of fluid released from the pipette by tracking the axial motion of a solid element that moves in tandem with the push rod tip or similar element that forces the fluid to leave the capillary tube.

Other objects, features and advantages of the present invention will become clear from the following description and drawings.

### BRIEF DESCRIPTION OF THE DRAWINGS

FIG. 1 is block diagram of one embodiment of the invention.

FIG. 2 is block diagram of a preferred embodiment of the invention where the fluid volume sensor is implemented as a volume setting sensor and a fluid release sensor.

FIG. 3 is a diagram of an optical volume sensing device capable of monitoring the volume setting of the pipette.

FIG. 4 is a diagram of a preferred embodiment of the invention using wireless transmission, where the data storage device is controlled by a personal computer.

FIG. 5 is a diagram of a preferred embodiment of the invention where the data transmission device includes a data cable, where the data storage device is controlled by a personal computer.

FIG. 6 is a diagram of a preferred embodiment of the invention using flash memory

### DETAILED DESCRIPTION OF THE INVENTION

The apparatus and method of the present invention offer a versatile solution to the drawbacks associated with manual pipettes. Using the apparatus and method of the present invention is significantly advantageous as it is cost effective, rapid, accurate, simple and efficient.

### Preferred Modes for Implementing the Invention:

### A. Fluid Volume Sensor

In one preferred embodiment, the invention is designed to work with a specific type of pipette, namely a pipette having a rotatable element positioned along the longitudinal axis of the pipette, where the rotatable element rotates in tandem with the volume delivery adjustment mechanism. One example of such a pipette is disclosed in U.S. Pat. No. 5,413,006 which is incorporated by reference, where the rotatable element is the push rod of the pipette. The rotatable element is usually cylindrically shaped but this should not be considered a limitation. There are other examples known in the art where the rotatable element is an element other than the push rod of the pipette such as, for example, a hollow sheath. In the event that the rotatable element is the push rod of the pipette, the volume is adjusted by turning of a rotary micrometer knob positioned at one end of the push rod.

In this embodiment of the invention, the fluid volume sensor is comprised of a volume setting sensor for sensing the volume setting of the pipette, a fluid release sensor for detecting when the fluid is dispensed from the pipette and one or more electronic assemblies for converting both the sensed volume and the information about when fluid is released from the pipette into one or more electronic signals. One possible function of the optional electronic assemblies is to convert inputted analogue electrical signals into outputted digital electrical signals. In this embodiment, the volume setting sensor and the fluid release sensor together function to detect the volume of fluid released from the pipette where the monitoring of fluid release from the pipette is optionally performed in real time. In this embodiment, the volume setting sensor operates by tracking the rotational motion of the rotatable element. Tracking is achieved by employing means for tracking translation motion, such as those incorporated within optical mice.

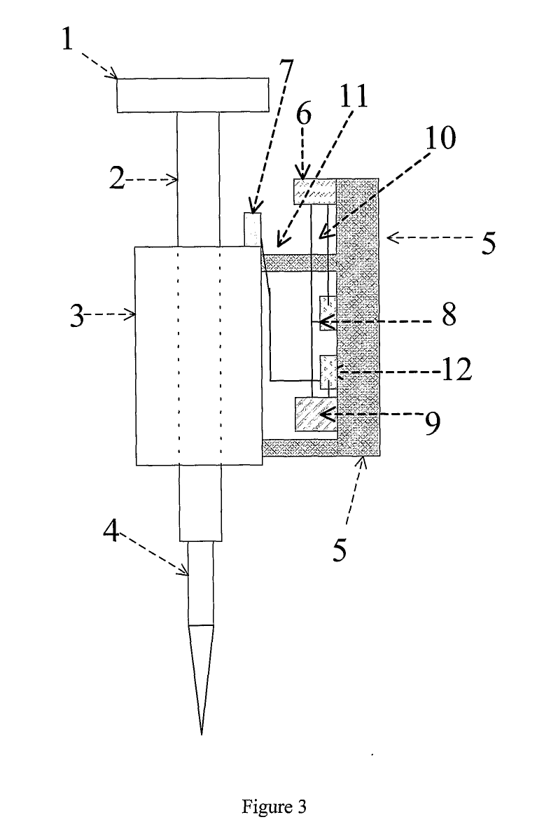

Thus, in this embodiment, the volume setting sensor may comprise a light source such as an LED and an optical sensor such as a complimentary metal-oxide semiconductor (CMOS) sensor. The electronic assembly may include a digital signal processor (DSP). The light source bounces light off the surface of the rotatable element and the reflected light is subsequently collected by the optical sensor. The optical sensor sends each image to the DSP for analysis. The DSP may then convert the analyzed information into a distance which reflects the extent of rotational motion that the element has undergone (FIG. 3, element 2). This distance is proportional to the volume setting of the pipette. It is to be understood explicitly that the scope of the present invention encompasses any suitable LED, CMOS and DSP units including units incorporated within commercial optical mice such as Microsoft® Intellimouse®.

In yet another preferred embodiment, the volume setting sensor also operates by tracking the rotational motion of the rotatable element. In this embodiment, a Hall effect transducer assembly tracks the rotational motion of the rotatable element. An example such a volume setting sensor is disclosed in U.S. Pat. No. 5,413,006 which is incorporated by reference.

In yet another preferred embodiment, the fluid volume sensor works with a pipette that dispenses fluid by forcing the fluid out of a capillary tube located at the distal end of the pipette, where the fluid is forced out by the stroking motion of a push rod tip or another solid element not permeable to fluid. Such a pipette is disclosed in U.S. Pat. No. 4,567,780 which is incorporated by reference. In that patent document a device for detecting how much fluid is in the pipette at any given moment is also disclosed, where this device operates by tracking the axial position of the push rod relative to a point fixed on the pipette body by means of a potentiometer, and then converting this value into a volume by taking into consideration the dimensions of the capillary tube and effecting the appropriate computation. In one embodiment of the invention, the fluid volume sensor operates by employing such a device to track in real time the instantaneous volumetric contents of the pipette. An electronic signal reflecting these values are subsequently transmitted by the transmission device to the storage device. If the pipette volumes in such a device are stored at rapid time intervals, say 5 times a second, then from the changes in instantaneous volumes it is possible to deduce the volumes of fluid aspirated into and dispensed from the pipette, and thus to produce a complete electronic record of the volumes of fluid aspirated into and dispensed from the pipette.

According to another preferred embodiment of the present invention, the volume sensor may be a miniature CCD camera mounted with an optical element such as a prism, which enables simultaneous viewing of the numerator of the pipette for the volume setting, and readout of the pipette volume setting itself by the CCD camera. The image generated by the camera is preferably acquired by an electronic unit mounted on the pipette body.

### B. Data Storage Device and the Data Transmission Device.

In one preferred embodiment, the data storage device is a personal computer controlling a peripheral persistent memory device, such as a hard disk, a floppy drive, a R/W CD ROM drive or a flash memory drive. The personal computer is configured to receive data from the data transmission device through one or more data input ports. In this embodiment, the data input ports may be implemented as USB I/O ports. Furthermore, in the embodiment where the data storage device is a personal computer and where the fluid volume sensor is comprised of a pipette volume setting sensor and a separate fluid release sensor, the personal computer can preferably receive data from the data transmission device through two data input ports. In this embodiment, a first electronic signal describing the current state of the pipette volume setting is received by the data storage device through a first input port, while a second electronic signal describing the current state of the pipette fluid release sensor is received by the data storage device through a second input port.

In this embodiment, the personal computer is programmed by control software to allow for the storage of the appropriate data in the peripheral persistent storage device in such a manner that a complete electronic record of all of the fluid dispensed from the pipette is recorded. In one embodiment of the control software, the personal computer is programmed to record the volume setting of the pipette only at a time when the electronic signal from the fluid release sensor indicates that fluid has been released from the pipette. In another embodiment, the time of fluid release is additionally recorded in the persistent memory peripheral as well. In yet another preferred embodiment of the control software, the volume setting is recorded at rapid intervals of typically 5 times a second even in the absence of a signal indicating that fluid has been dispensed from the pipette. This data is augmented with the times that the fluid release sensor indicates that fluid has been dispensed from the pipette, allowing for the recording of an even more complete picture of actual pipette operation.

Additional embodiments of the data storage device include a laptop computer, a handheld computer, a tablet device, and a Personal Digital Assistant (PDA). Further additional embodiments of the data storage device include a flash memory device, comprising of a flash memory chip assembly, and a flash memory controller. Data recorded to the flash memory device may be uploaded to a personal computer at the convenience of the user.

In the event that the data storage device is a flash memory device, the preferable embodiment of the data transmission device is a data bus.

In the event that the data storage device is a personal computer, PDA, or handheld computer, there are several alternatives for the data transmission device. For example, in one embodiment the data transmission device is a cable connecting the electronic assembly to the data storage device. Alternatively, the data transmission device may comprise a wireless transmitter and a suitable wireless receiver. The transmitter and the transmitting protocol may be, for example, based upon current wireless data transmission technologies like WI-FI® or BLUETOOTH® among others. In some embodiments, for example, the wireless transmitter is physically connected to the pipette, while the wireless receiver is physically connected to the data storage device. The wireless transmitter needs to be operated at a distance from the data transmission device of no more than the maximal distance that is required for receiving the transmitted signals.

The following examples are presented to provide a more complete understanding of the invention. The specific techniques, conditions, materials, proportions and reported data set forth to illustrate the principles of the invention are exemplary and should not be construed as limiting the scope of the invention.

### DETAILED DESCRIPTIONS OF PREFERRED EMBODIMENTS

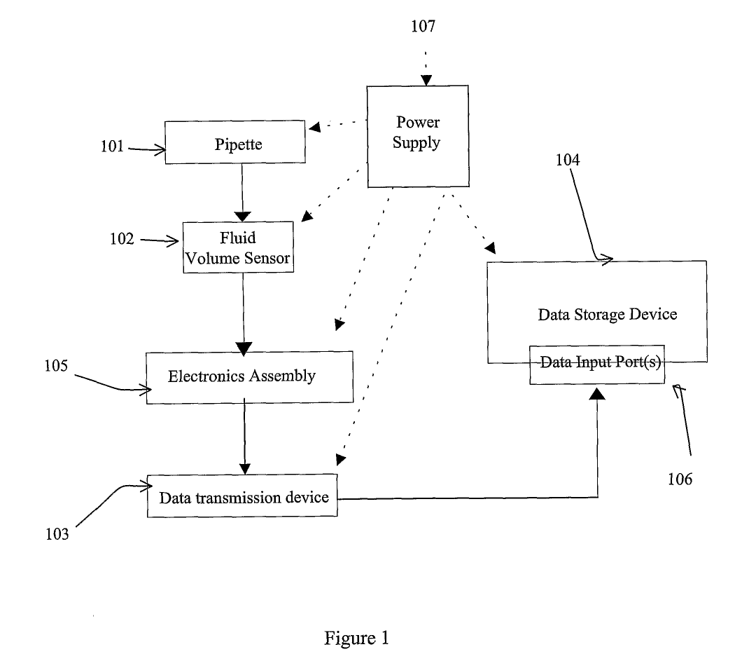

Reference is now made to FIG. 1, which is a block diagram illustrating one preferred embodiment of the invention. In this embodiment, the system of the invention comprises a fluid volume sensor 102 that determines the volumes of fluid released from the pipette 101 and outputs one or more electrical signals determined by the volume of fluid released by the pipette. One or more optional electronic assemblies 105 receive one or more electrical signals and output one or more processed electrical signals to the data transmission device 103 which subsequently transmits the processed electrical signals to the data storage device 104. One possible function of the optional electronic assemblies is to convert inputted analogue electrical signals into outputted digital electrical signals. Alternatively, in different embodiments, this optional functionality could incorporate one or more of the following elements: the fluid volume sensor 102, the data transmission device 103 or the data storage device 104. In the event that the electronic assembly 105 is not present, the data transmission device 103 receives the unprocessed electrical signals from the fluid volume sensor 102 and transmits the unprocessed electrical signals to the data storage device 104.

In some embodiments, the fluid volume sensor 102 is preferably installed in a housing to allow for mounting onto a pipette. In some embodiments at least part of the data transmission device 103 is preferably housed to allow for mounting to a pipette.

The data storage device 106 receives either the processed or unprocessed electrical signals from the data transmission device 103 either directly or through an optional data input port 106. In different preferred embodiments of the invention, the data input port could be a USB port, an RS232 port, a serial data port, a parallel data port, or a PS/2 port. The data storage device stores to persistent memory data reflecting the volumes of fluid dispensed from the pipette. The data storage device has an optional clock, and thus the data storage device can optionally store the various times at which the volumes of fluid have been dispensed from the pipette.

The preferred embodiment of the invention described in FIG. 1 also includes a power supply 107. In one embodiment, this power supply is a battery. In different embodiments of the invention, the power supply 107 can optionally provide power for any or all of the pipette 101, the fluid volume sensor 102, the optional electronics assembly 105, the data transmission device 103, and the data storage device 104. In some embodiments, the power supply 107 provides power for one or more such elements and then this electrical power subsequently flows to one or more another elements. For example, in one embodiment the fluid volume sensor receives electrical power from a battery, and one of the electronics assemblies receives electrical power indirectly from the same battery through an electrical connection to the fluid volume sensor.

Other sensors could be incorporated into a pipette, such as a sensor that monitors the temperature or pH of fluid aspirated into or dispensed from a pipette: the fluid volume sensor could also be adapted to record temperature and pH data. This data would subsequently be transmitted by the data transmission device to the data storage device.

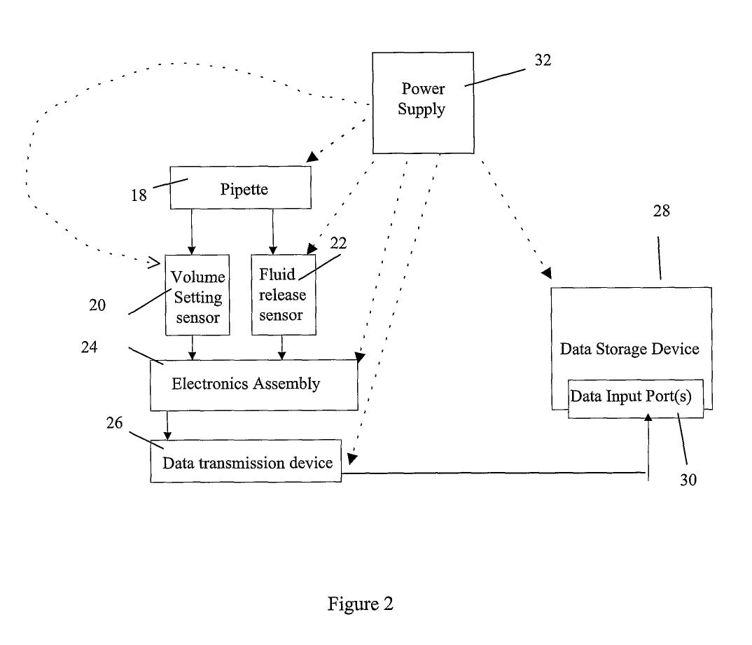

Reference is now made to FIG. 2, which is a block diagram illustrating yet another preferred embodiment of the invention. In this embodiment, in order to monitor the volume of fluid dispensed from the pipette at various time points, the volume setting sensor 20 senses the volume setting of the pipette while the fluid release sensor 22 detects when the volume of fluid is released from the pipette 18. The volume setting sensor 20 outputs one or more electrical signals determined by the volume setting of the pipette while the fluid release sensor 22 outputs one or more electrical signals determined by the status of the fluid release mechanism of the pipette. Both the volume setting sensor 20 and the fluid release sensor 22 each transmit one or more electrical outputs signals to either one or more optional electronics assemblies 24 or directly to the data transmission device 26. One possible function of the optional electronic assemblies is to convert inputted analogue electrical signals into outputted digital electrical signals. Alternatively, in different embodiments, this optional functionality could incorporate one or more of the following elements: the volume setting sensor 20, the fluid release sensor 22, the data transmission device 26 or the data storage device 28. In some embodiments, data transmission device 26 receives unprocessed electrical signals directly from the volume setting sensor 20. In some embodiments, data transmission device 26 receives electrical signals directly from the fluid release sensor 22.

The embodiment of the invention described in FIG. 2 also preferably includes a power supply 32. In one embodiment, this power supply is a battery. In different embodiments of the invention, the power supply 32 can optionally provide power for the pipette 18, the volume setting sensor 20, the fluid release sensor 22, the optional electronics assemblies 24, the data transmission device 26, and the data storage device 28. In some embodiments, the power supply 32 provides power for one or more such elements and then this electrical power subsequently flows to one or more different elements. For example, in one embodiment the volume setting sensor receives electrical power from a battery, and one of the electronics assemblies receives electrical power indirectly from the same battery through an electrical connection to the volume setting sensor.

The data storage device 28 receives either the processed or unprocessed electrical signals from the data transmission device 26 either directly or through an optional data input port 30. In different preferred embodiments of the invention, the data input port could be a USB port, an RS232 port, a serial data port, a parallel data port, or a PS/2 port. The data storage device 28 stores to persistent memory data reflecting the volumes of fluid dispensed from the pipette. The data storage device has an optional clock, and thus the data storage device can optionally store the various times at which the volumes of fluid have been dispensed from the pipette.

In some embodiments, the data storage device 28 is controlled by a controller, either electronic or programmed with controller software. In some embodiments, the controller instructs the data storage device each time it receives a signal indicating that fluid is dispensed from the pipette, to store the value reflecting the volume setting of the pipette at the time that fluid is released. In other embodiments, the controller instructs the data storage device to store both the value reflecting the volume setting of the pipette as well as a value reflecting the status of the fluid release mechanism, at predetermined time intervals such as 5 times per second. This data together constitutes a complete electronic record of all of the fluid dispensed from the pipette.

Reference is now made to FIG. 3, which is a schematic illustration of one preferred embodiment of a fluid volume sensor capable of detecting the volume of fluid released from the pipette. The fluid volume sensor is adapted to be to be used with a pipette and the fluid volume sensor is comprised of a volume setting sensor and a released fluid sensor. The parts of the pipette shown in FIG. 3 are a pipette body 3 having an optional pipette tip 4 at the distal end and a push button 1 at the proximal end. The push button 1 is connected to a rotatable push rod 2 where the volume setting of the pipette is determined by the rotational position of the rotatable push rod 2. The optical rotational motion sensor 6 monitors the rotational motion of the push rod preferably by bouncing light off of the surface of the push rod from a light source, collecting the reflected light in an optical sensor device and then sending an electrical signal determined by the collected light via electrical connection 10 to the electronics assembly 8 which processes the electrical signal and outputs a processed first output electronic signal. The electronics assembly 8 includes electronic means for signal processing and in one embodiment the electronics assembly 8 is a DSP (digital signal processing) unit. In alternative embodiments, electronics assembly 8 outputs the processed first output electronic signal to a data transmission device (not shown) and to an optional display (not shown).

In the preferred embodiment shown in FIG. 3, the volume setting of the pipette is determined by the rotational position of the rotatable push rod 2. In other preferred embodiments, the volume setting of the pipette is determined by a different rotatable element other than the push rod 2, and the fact that in FIG. 3 the volume setting sensor tracks specifically the rotational motion of the push rode should be considered to be an illustration by example, and should be considered in no way limiting.

The user of the specific pipette in FIG. 3 releases the fluid preferably by depressing the push button, and the microswitch assembly 7 detects when the push button is depressed and transmits an electrical signal via electrical connection 11 to the optional electronics assembly 12 which processes the electrical signal and outputs a second processed output electronic signal. In alternative preferred embodiments, the electrical signal is transmitted directly to a data transmission device (not shown) or to an optional LCD display (not shown).

FIG. 3 also discloses a power supply 9 which can supply power to the optical sensor 6, the microswitch assembly 7, and the electronic assemblies 8 and 12. FIG. 3 illustrates a single optional power supply but this should in no way be construed as limiting, and in some embodiments of the invention various electronic components displayed in FIG. 3 may be supplied with electrical power from more than one power source.

It is possible to build a volume sensor device using all of the parts shown in FIG. 3 with the exception of parts associated with the fluid release sensor, such as the microswitch assembly 7 and the electronics assembly 12. Although the optional display is not shown in FIG. 3, it is possible to export an electronic signal from the electronics assembly 8 to a display.

According to another preferred embodiment of the present invention, the volume sensor may be a miniature CCD camera mounted with an optical element such as a prism, which enables simultaneous viewing of the numerator of the pipette for the volume setting, and readout of the pipette volume setting itself by the CCD camera. The image generated by the camera is preferably acquired by the electronic unit mounted on the pipette body and the data is preferably transmitted by a wireless protocol to a computer for further processing and storage in the electronic lab book. The procedure of the image acquisition and processing is initiated by a start signal generated when the volume release button is suppressed.

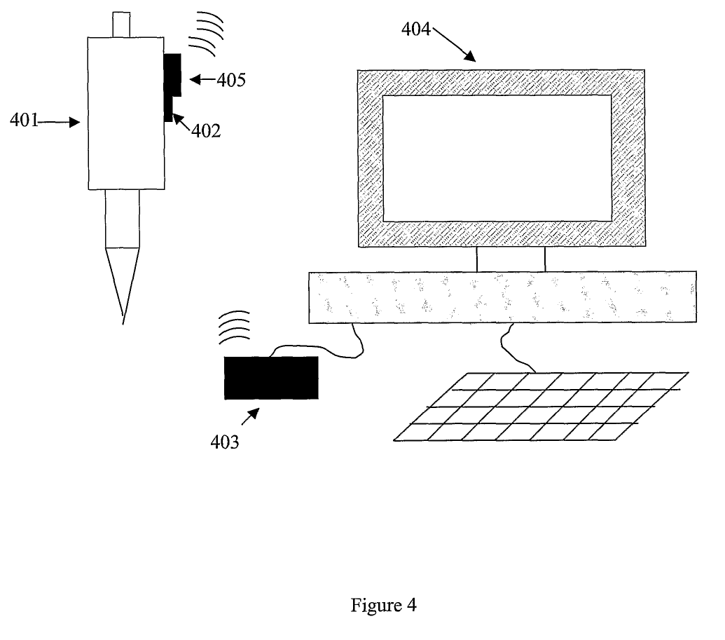

Reference is now made to FIG. 4, which is block diagram illustrating another preferred embodiment of the invention. In FIG. 4, there is a pipette 401, a fluid volume sensor 402 capable of detecting the volume of fluid released from the pipette, a data transmission device 405 that transmits information regarding the volumes of released fluid data in a wireless fashion, a data receiving device 403 that receives data transmitted from the device 405, and a personal computer 404 that receives data from the device 403. The personal computer is equipped with persistent memory means such as a hard drive, and stores to persistent memory data representing the quantities of fluid dispensed from the pipette 401.

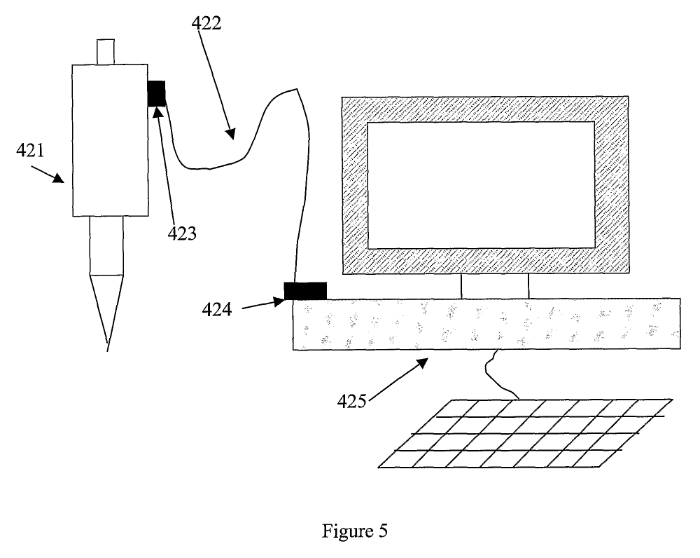

Reference is now made to FIG. 5, which is block diagram illustrating another preferred embodiment of the invention. In FIG. 5, there is a pipette 421, a fluid volume sensor 423 capable of detecting the volume of fluid released from the pipette, a data transmission device in the form of a data cable 422, and a personal computer 425 that receives data from the data cable 422 through data input port 424. The personal computer 425 is equipped with persistent memory means such as a hard drive, and stores to persistent memory data representing the quantities of fluid dispensed from the pipette 421.

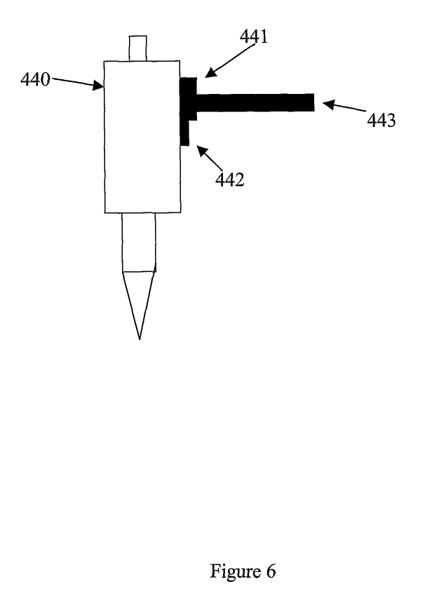

Reference is now made to FIG. 6, which is block diagram illustrating another preferred embodiment of the invention. In FIG. 6, there is a pipette 440, a fluid volume sensor 442 capable of detecting the volume of fluid released from the pipette, a data transmission device 441 which is in this case a data bus, and flash memory device 443. The flash memory device stores data representing the quantities of fluid dispensed from the pipette 440.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

1-25. (canceled)

26. A data acquisition apparatus adapted for use with a fluid dispensing device, said data acquisition apparatus comprising:
a fluid volume sensor, said fluid volume sensor detecting the volume of fluid released from said fluid dispensing device and producing one or more electrical signals determined by the volume of fluid released from said fluid dispensing device;
a data transmission device configured to receive said one or more electrical signals, and
a data storage device receiving said one or more electrical signals from the transmission device, and storing them.

27. The data acquisition apparatus of claim 26, further comprising an electronic assembly receiving said one or more electrical signals from said fluid volume sensor and producing one or more processed electronic signals, said electronic assembly capable of outputting the one or more processed electronic signals to the data transmission device.

28. The data acquisition apparatus according to claim 26, wherein the fluid dispensing device is selected from a manual pipette and an automated pipette.

29. The data acquisition apparatus according to claim 28, wherein said fluid volume sensor is adapted to be mounted on said pipette so as not to hinder the normal operation of said pipette.

30. The data acquisition apparatus according to claim 26, wherein said fluid volume sensor is capable of detecting the volume of fluid released from the pipette in real time.

31. The data acquisition apparatus according to claim 26, wherein said data transmission device is capable of transmitting said one or more electronic signals in real time.

32. The data acquisition apparatus according to claim 26, wherein said data storage device is capable of storing said one or more electronic signals in real time.

33. The data acquisition apparatus according to claim 28, further comprising an electronic clock configured to output the current time directly or indirectly to the data storage device.

34. The data acquisition apparatus according to claim 28, wherein said pipette comprises:
a) a volume adjustment setting device for determining the volume setting of the pipette; and
b) a fluid release control for releasing from the pipette a quantity of fluid determined by the volume adjustment setting of the pipette.

35. The data acquisition apparatus according to claim 34, wherein the fluid volume sensor comprises:
a) a volume setting sensor, the volume setting sensor capable of detecting the volume setting of said pipette and producing a first electric signal determined by the volume setting of the pipette;
b) a fluid release sensor, the release sensor capable of producing a second electronic signal when fluid is released from said pipette.

36. The data acquisition apparatus according to claim 28, wherein said pipette further comprises a rotatable element that rotates in tandem with the volume adjustment setting device of said pipette, wherein the configuration of said rotatable element relative to the pipette body determines the volume setting of said pipette.

37. The data acquisition apparatus according to claim 35, wherein said volume setting sensor is adapted to be physically mounted onto a pipette, said volume setting sensor comprising:
a) a light generating source capable of reflecting light off the surface of said rotatable element;
b) an optical sensor positioned so as to receive light reflected off the surface of said rotatable element; and
c) an electronic assembly capable of computing from light patterns collected by the optical sensor the rotational configuration of said rotatable element, and of outputting one or more electronic signals determined by the volume setting of said pipette.

38. The data acquisition apparatus according to claim 37, wherein said rotatable element is a push rod positioned along the longitudinal axis of said pipette, and further comprising a CCD device determining the position of said push rod along said longitudinal axis of said pipette.

39. The data acquisition apparatus according to claim 36, wherein said volume setting sensor comprises:
a) a Hall effect transducer assembly capable of producing at least two transducer signals related to the rotational motion of said rotatable element, and
b) a signal processing electronics assembly capable of comparing at least two transducer signals in order to compute the volume setting of said pipette.

40. The data acquisition apparatus according to claim 35, wherein the pipette further comprises a plunger assembly for actuating a push rod when said pipette is actuated to pick-up liquid.

41. The data acquisition apparatus according to claim 35, wherein the pipette further comprises a plunger assembly and wherein said fluid volume sensor comprises:
a) a linear position sensor developing an electronic signal proportional to the distance said plunger assembly moves from a first stop, wherein the linear position sensor includes a potentiometer comprising:
a linear resistive element distributed on the body of the pipette along the path of said plunger assembly; and
a wiper in electrical contact with the resistive element and carried by the plunger assembly; and
b) a unit for computing the released volume of fluid from the pipette from the time dependent axial position of the plunger assembly.

42. The data acquisition apparatus according to claim 28, wherein the data storage device comprises persistent memory means and the data input port is selected from the group consisting of a USB port, RS-232 port, serial data port, parallel data port, and PS/2 port.

43. The data acquisition apparatus according to claim 1, wherein the data transmission device employees an appropriate transmission protocol selected from the group of consisting of TCP/IP, BLUETOOTH™ and WIFI™.

44. The data acquisition apparatus according to claim 26, wherein the data transmission device is selected from a data cable and a data bus.

45. The data acquisition apparatus according to claim 26, wherein the data transmission device is selected from a data cable and a data bus.

46. The data acquisition apparatus according to claim 28, wherein the data transmission device is at least partially wireless, said data transmission device comprising
a) a wireless transmission device for transmitting wireless signals; and
b) a wireless receiving device for receiving said wireless signals from said wireless transmission device.

47. The data acquisition apparatus according to claim 28, wherein the persistent memory data storage device comprises at least one of a personal computer.

48. A method for recording and storing data relating to the fluid dispensing operations of a pipette, said method comprising:
a) sensing the volume of fluid released from the pipette;
b) producing an electronic signal determined by the volume of fluid released from the pipette;
c) transmitting said electronic signal to a storage device; and
d) recording the electronic signal in the storage device.

49. A method for recording and storing in real time data relating to the fluid dispensing operations of a pipette having a volume setting and a fluid release means, said method comprising:
a) monitoring the volume setting of said pipette;
b) monitoring the status of the fluid release means in order to detect at which moment fluid is released from said pipette;
c) producing a first electronic signal determined by the volume setting of the pipette;
d) producing a second electronic signal determined by the status of the fluid release mechanism;
e) transmitting said electronic signals to a storage device; and
f) recording the electronic signal in the storage device.

50. The method of claim 49, further comprising the step of recording the time of generation of the second signal in the storage device.
